(19) United States
(12) Patent Application Publication
(10) Pub. No.: US 2007/0022009 A1
(43) Pub. Date: Jan. 25, 2007

(54) Exchange and interactive ad server system and method

(76) Inventors: John Michael Cataldi, Sugar Hill, GA (US); Barry Derrick, Lawrenceville, GA (US)

Correspondence Address: John Michael Cataldi, Suite 108-206, 5885 Cumming Hwy, Sugar Hill, GA, 30518, US

(21) Appl. No.: 11/492,748

(22) Filed: Jul. 25, 2006

Related U.S. Application Data
(60) Provisional application No. 60/701,835, filed on Jul. 25, 2005.

(51) Int. Cl. G06Q 30/00

(52) U.S. Cl. 705/14

(57) ABSTRACT

The exchange & interactive ad server system and method allow an advertiser to bid or directly purchase publisher inventory across both interactive and traditional media networks. Furthermore, the system further allows the automation and optimization of advert, publisher networks, and consumer rewards via a continuous feedback loop of consumer interactions, consumer data, and analysis of behavioral algorithms.

Priority on U.S. Provisional Patent Application, Ser. No. 60/701,835, filed Jul. 25, 2005, and entitled “Lifestyle ad server”, is claimed.

### BACKGROUND

I. Field of the Invention

This invention relates generally to the field of advertising services and more particularly to a targeted media exchange system and method.

II. Description of the Related Art

Today, traditional media spending is approximately $500 Billion dollars as compared to interactive advertising which is estimated as a $14.7 Billion dollar market (VSS Research, Borrell Associates). Yet Communications spending is expected to be the 4^{th} fastest growing sector of the U.S. economy in the 2004-2009 period, expanding at a compound annual rate of 6.7 percent, surpassing the trillion-dollar mark in 2008, and reaching $1.109 trillion in 2009 compared with the nominal GDP growth of 6.0 percent during the same forecast period. Local advertising has increased dramatically by a factor between 25-46%, depending upon the sited research, with respect to both interactive and traditional media (Borrell Associates, MSNBC, ADB).

Identifying and serving specific advertising media to the buying behavior of a targeted market demographic can provide a critical and competitive edge for any business. Today, customer identification, trend analysis, demographic targeting, and smart ad serving is rapidly becoming the foundation of interactive media purchasing. Yet aggregation, analysis, and use of this valuable information to make educated buying decisions in the physical based media markets is compartmentalized, over simplified, or not applied to most traditional based media purchases.

Traditional media like TV, magazines, and billboards are push/broadcast in nature. All consumers viewing such media receive exactly the same information. It is then left for each consumer to ‘consume’ only such information as she needs or finds relevant. Thus, the challenge for an advertiser is to choose the media venues that most likely will be consumed by the targeted consumer given a specific advertiser's brand. The ascent is, therefore, on reducing wastage by increasing both the targeting, and reporting on the clients uptake, to better improve the consumers response to a given advertiser brand.

The Internet is a much more dynamic advertising medium, allowing advertisers to change, target, and optimize their marketing message to a prospective consumer. Yet unlike traditional media which creates a constant marketing message, that in some cases can cause a change in the consumers behavior though potentially less relevant to the consumers specific needs, internet search engines focus on the relevant needs of the consumer based upon specific key word searches. An additional challenge of the internet is the time of exposure. Unlike traditional media, exposure is limited to the time that one is in front of the computer. Thus, the consumer can only be influenced during the duration of time that they are connected to the internet. Moreover, a recent Jupiter Research (a Jupiter media Corp. division) study found “most online consumers still don't know exactly what they want when surfing for products online.” The study suggests marketing should always be proactive, with specific calls to action for different demonstrated behaviors. It also promotes the use of behavioral targeting as an inferred solution to mend the data gap between investigative/information-seeking actions (search) and navigational/experiential actions (online media).

Mobile devices are becoming more like interactive devices, providing access to the Internet, Bluetooth, and in come case global positioning (GPS). Mobile marketing is an emerging market with up to a 95% saturation rate of both adolescent and adult markets. The exposure rate, or carry rate (the time an individual carries their mobile device), of mobile phones averages 12 hours a day. Yet marketing on these devices relies heavily upon the consumer using a mini-browser which connects to the Internet, or a downloaded application. Unlike the Internet, very little interaction occurs other than voice communications and SMS applications.

There's currently a gap between internet search and media. Search, defined as the methodology to connect consumers with brands both directly and relevant to their buying habits online, still exists in a silo, apart from other media. Whatever terms a user searches, results are only based on the word that user typed in, rather than interpreting where that user has been or who they are as individuals with limitations to porting or following the consumer on a multitude of devices and venues. For example, online, behaviorally targeted banners don't take into consideration which keywords that user previously searched. Traditional media marketing does not dynamically change to target their buying behavior when in proximity to a prospective client. Lastly, mobile devices, though having the greatest client reach, are limited to porting the advertiser's message or reporting key consumer demographics back to the advertiser.

If behavioral targeting is about understanding consumer actions and patterns (and it is!), then the data marriage, or convergence, between search and targeting is critical to future industry growth.

THE MORAL OF THE STORY: Integrating consumer search data with behaviorally targeted interactive media is a logical step toward a holistic understanding of how consumers use the online and mobile mediums.

### SUMMARY

In general, the invention features the exchange & interactive ad server system and method that will allow an advertiser to purchase targeted advertising across a multitude of media networks that include, but are not limited to, traditional media, internet, and mobile venues. Under an exchange format, the publishers, owners, or agents of the media venues will have uploaded their inventory to the exchange so that it can be displayed to the advertisers to bid on or to directly purchase from. Advertiser purchases may be that of a single ad or and entire ad campaign, in which the exchange may also dynamically create the most relevant ad pathways for the advertisers to syndicate their brand message. Ad purchases feature a convergence of media types to include print, outdoor, internet, mobile, and physical based objects (IE NASCAR sponsorship).

The interactive ad server updates its consumer adverts to better target the buying behavior of the consumer based upon the consumer's interaction within the various media. Through the analytics engine, the data is then analyzed and stored in a cumulative consumer database. This allows a more effective consumer reach by optimization of both the adverts and media venues to better target individual or group consumer buying behavior.

In one implementation, the exchange is a web portal developed from a modular design system, which includes a plurality of design modules and an interface for selecting a subset of both publishers and advertisers.

In one implementation a publishing exchange can be a website

In another implementation a publisher can be a magazine

In another implementation a publisher can be a news paper

In another implementation a publisher can be outdoor media

In another implementation a publisher can be indoor media

In another implementation a publisher can be object media

In another implementation a publisher can be a mobile device

In another implementation a publisher can be a PDA

In another implementation a publisher can be a smart device

In another aspect, the invention features an exchange and interactive ad server system and method, including a requesting interface that is connected to a network that provides a data exchange of consumer based information to the ad server.

In one implementation the requesting interface is a website

In another the requesting interface is a mobile device

In another the requesting interface is a Bluetooth node

In another the requesting interface is a RFID

In another the requesting interface is a smart card/media

In another the requesting interface is a kiosk

In another aspect, the requesting interface connects through the transport to an intelligent dynamic ad server, which compiles the most relevant advertisements to display based upon, but not limited to predicted consumer behavior versus relevance of the advertisement to the consumer.

In another aspect, the unified consumer object engine pulls and pushes data to the consumer object data store and the temporal data store. The consumer data store includes both general consumer information based upon grouped consumers data, and individual profile data of specific consumers. The temporal data store is an accumulation of harvested data from a multitude of data sources.

In one implementation, the temporal data store pulls data from all interactivity of the consumer through the requesting interface

In another implementation, the temporal data store pulls data from public data sources to include all publicly accessible print and electronic media

In another implementation, the temporal data store pulls data from partnered data sources

In another aspect, the correlation engine pulls and pushes data between the consumer object and the temporal data store. Thus, the correlation engine builds the consumer data object from all available data that is considered relevant to the consumer object demographic, behavior, or any other relevant data points.

In one implementation the consumer data object is an individual consumer

In another consumer data object is a group of consumers within a specific demographic

In another aspect, the consumer data object is a group of consumers with in multiple demographics

In another aspect, the analytics engine tracks the effective performance of ads being served versus consumer uptake or product, actions to buy, or desired advertiser change in consumer behavior. Analytical effectiveness can be tracked via desired consumer behavior from any requesting interface, a call center or location based responses.

In another aspect, the consumer rewards interface provides positive reinforcement for consumer participation in advertiser promotions. The consumer rewards targets and dynamically updates consumer rewards selections based upon previous buying behavior and/or additional informational requirements of the consumer object data store in order to deepen the profile of an individual consumer or group.

### BRIEF DESCRIPTION OF THE DRAWINGS

FIG. 1 illustrates the process by which a simple Ad Request is sent from a Requesting Interface via a Transport to the Intelligent Dynamic Ad Server, the amplification of data contained in the Ad Request through interaction with the Unified Consumer Object Engine, the retrieval of relevant advertising from the Ad Data Store, and the subsequent return of an Ad Serve from the Intelligent Dynamic Ad Server via the Transport to the Requesting Interface.

FIG. 2 illustrates the process by which an Ad Request with Lead Generation is sent from a Requesting Interface via a Transport to the Intelligent Dynamic Ad Server, the amplification of data contained in the Ad Request through interaction with the Unified Consumer Object Engine, the retrieval of relevant advertising from the Ad Data Store, and the subsequent return of an Ad Serve from the Intelligent Dynamic Ad Server via the Transport to the Requesting Interface. Upon successful completion of the interactive Ad Serve, qualified lead information is sent from the Requesting Interface via a Transport to the Intelligent Dynamic Ad Server which then stores the lead information in the Ad Data Store.

FIG. 3 illustrates the process by which new Consumer Object data is acquired from both internal and external sources without the interaction required by an Interface issued Ad Request.

FIG. 4 illustrates the process by which the Correlation Engine updates and amplifies Consumer Objects contained in the Consumer Object Data Store by continually processing the available information in the Temporal Data Store.

FIG. 5 illustrates the process by which external analytical data is captured by the Analytics Engine and integrated with analytical data captured by the Intelligent Dynamic Ad Server in association with advertising campaigns contained in the Ad Data Store.

FIG. 6 illustrates the interaction of Advertisers and Publishers via the Free Market Engine allowing for purchase of Ad Space both at a set price and via bid.

FIG. 7 illustrates the interaction of Consumers with the Consumer Rewards Interface which allows them to claim rewards defined in advertising campaigns residing in the Ad Data Store.

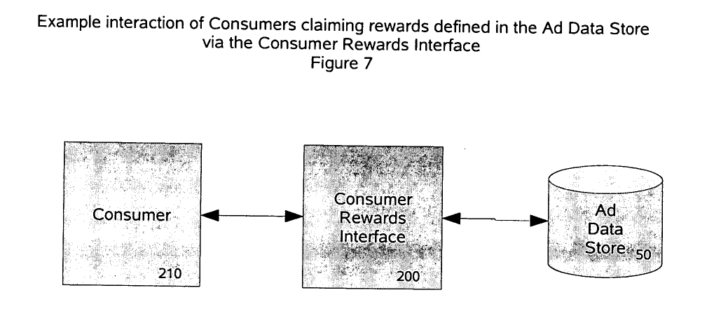

### DETAILED DESCRIPTION

In general, the systems and methods described herein provide a method to serve both interactive and non-interactive advertising to a consumer or consumers, a unified distribution point for advertisers to purchase and manage advertising space from multiple sources and media types, and a distribution point for publishers to sell their advertising space to advertisers.

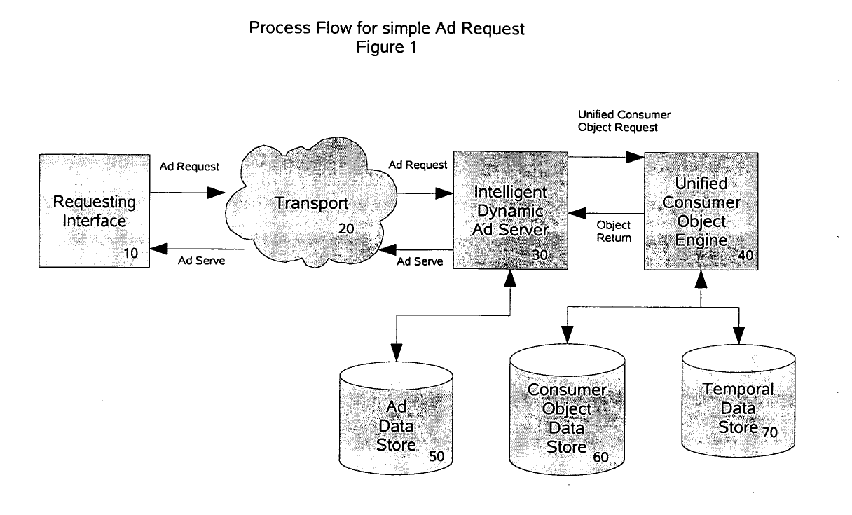

Referring to the drawings wherein like reference numerals designates corresponding parts throughout the several figures. Reference is made first to FIG. 1 which illustrates the process flow of a simple advertising request from a requesting interface 10, through a transport 20, to the intelligent dynamic ad server 30. Upon receiving the advertising request the intelligent dynamic ad server 30, disassembles the request and extracts any embedded consumer reference data, which may contain data elements such as demographical information, the consumer's interests, the consumer's income level, etc. Once the consumer reference data has been extracted, the intelligent dynamic ad server 30 sends a request including the consumer reference data to the unified consumer object engine 40. The unified consumer object engine 40 searches the consumer object data store 60 for any consumer objects that match the reference data included in the request from the intelligent dynamic ad server 30. The unified consumer object engine 40 attempts to return a specific consumer object that is a direct match for the reference data, thereby identifying the unique consumer involved. Failing that, the unified consumer object engine 40 returns the most granular consumer object possible, returning a very general object based solely on the reference data provided in the original request if a more relevant match can not be found. After the object has been sent to the intelligent dynamic ad server 30, the unified consumer object engine 40 writes the reference data included in the original request to the temporal data store 70 for later inclusion into the consumer object data store 60. Based upon the consumer object returned by the unified consumer object engine 40, the intelligent dynamic ad server 30 searches the ad data store 50 for an active advertisement that closely matches the parameters established in the consumer object. Should more than one active advertisement be found that matches the parameters, the intelligent dynamic ad server 30 will select the advertisement to be severed based upon the profit potential or other defined factors of the available advertisements. When an advertisement is chosen, the intelligent dynamic ad server 30 sends the advertisement via the transport 20, to the requesting interface 10, where the advertisement is presented to the consumer.

In one implementation of FIG. 1, the requesting interface 10 may be a web browser and the transport 20 the Internet.

In another implementation of FIG. 1, the requesting interface 10 may be a mobile device and the transport 20 a wireless network.

In another implementation of FIG. 1, the requesting interface 10 may be a computer video display and the transport 20 a local area network.

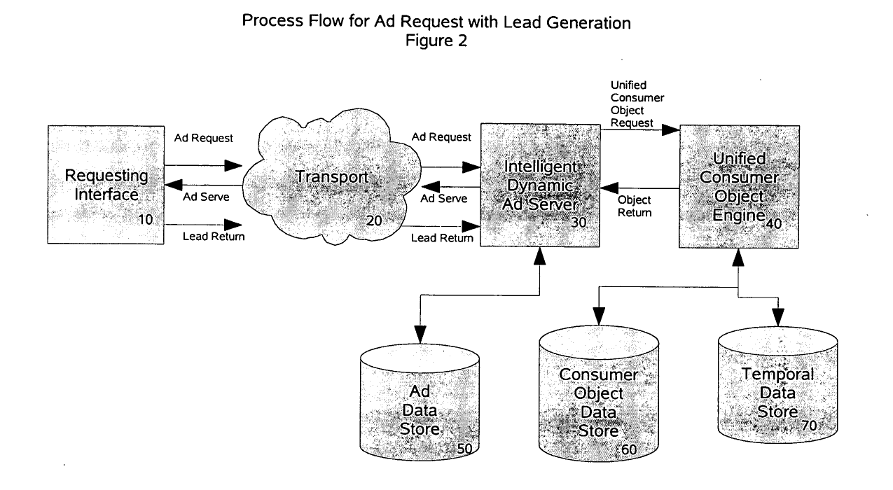

Referring now to FIG. 2, the process flow of an advertising request with lead generation from a requesting interface 10, through a transport 20, to the intelligent dynamic ad server 30 is illustrated. Upon receiving the advertising request the intelligent dynamic ad server 30, disassembles the request and extracts any embedded consumer reference data, which may contain data elements such as demographical information, the consumer's interests, the consumer's income level, etc. Once the consumer reference data has been extracted, the intelligent dynamic ad server 30, sends a request including the consumer reference data to the unified consumer object engine 40. The unified consumer object engine 40, searches the consumer object data store 60 for any consumer objects that match the reference data included in the request from the intelligent dynamic ad server 30. The unified consumer object engine 40 attempts to return a specific consumer object that is a direct match for the reference data, thereby identifying the unique consumer involved. Failing that, the unified consumer object engine 40 returns the most granular consumer object possible, returning a very general object based solely on the reference data provided in the original request if a more relevant match can not be found. After the object has been sent to the intelligent dynamic ad server 30, the unified consumer object engine 40 writes the reference data included in the original request to the temporal data store 70 for later inclusion into the consumer object data store 60. Based upon the consumer object returned by the unified consumer object engine 40, the intelligent dynamic ad server 30 searches the ad data store 50 for an active advertisement that closely matches the parameters established in the consumer object. Should more than one active advertisement be found that matches the parameters, the intelligent dynamic ad server 30 will select the advertisement to be severed based upon the profit potential or other defined factors of the available advertisements. When an advertisement is chosen, the intelligent dynamic ad server 30 sends the advertisement via the transport 20, to the requesting interface 10 where the advertisement is presented to the consumer. Should the consumer choose to respond to the interactive advertisement, the consumers response is sent from the requesting interface 10, through a transport 20, to the intelligent dynamic ad server 30 and stored in the ad data store 50 in relation to the specific advertisement that was served.

In one implementation of FIG. 2, the requesting interface 10 may be a web browser and the transport 20 the Internet.

In another implementation of FIG. 2, the requesting interface 10 may be a mobile device and the transport 20 a wireless network.

In another implementation of FIG. 2, the requesting interface 10 may be a interactive kiosk and the transport 20 a local area network.

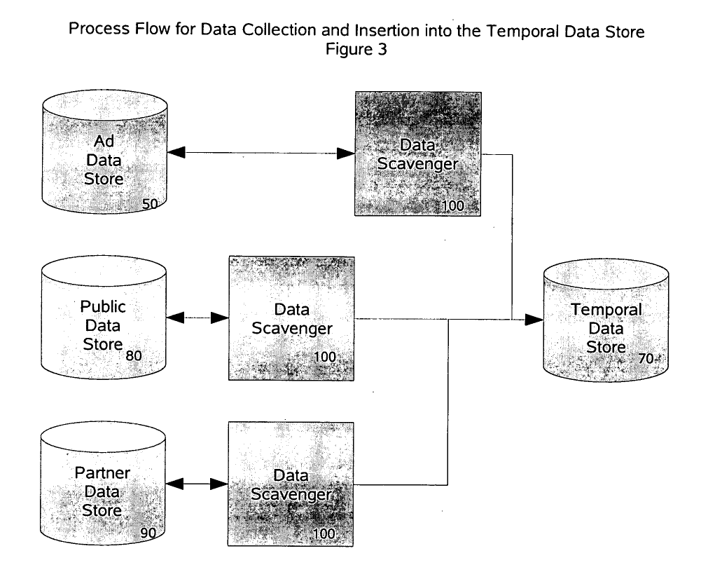

Referring now to FIG. 3, the process flow for data collection and insertion into the temporal data store 70 from the ad data store 50, public data stores 80, and partner data stores 90, via data scavengers 100 is illustrated. Data scavengers 100 are processes that search out and retrieve data for the purposes of refining consumer objects within the consumer object data store 60 from both internal sources such as the ad data store 50, and external sources such as public data stores 80, and partner data stores 90. Data scavengers 100 are designed and constructed specifically to interface with their intended target data source. In common implementation, multiple Data scavengers 100 will operate concurrently on different target data sources. Once data has been extracted from the target data source it is immediately inserted into the temporal data store 70 to await processing by the correlation engine 110.

In one implementation of FIG. 3, the public data store 80 may be public web pages residing on the Internet and the partner data store 90 may be a database owned by a partner organization.

In another implementation of FIG. 3, the public data store 80 may be a public database and the partner data store 90 may be a database to which access may be licensed.

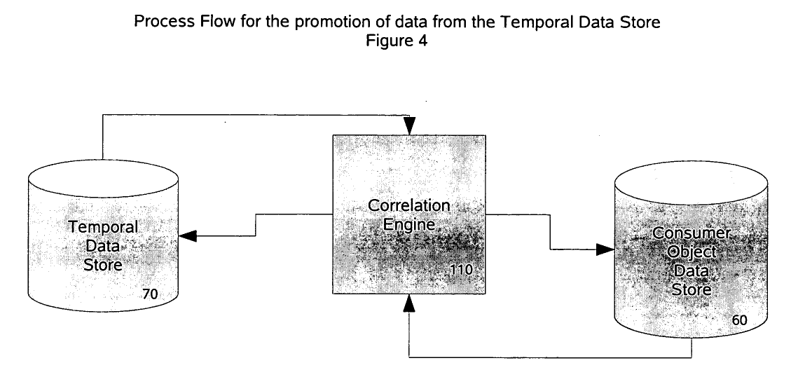

Referring now to FIG. 4, the process flow for the promotion of data from the temporal data store 70 to the consumer object data store 60 via the correlation engine 110 is illustrated. The correlation engine 110 is a process which continually scans data residing in the temporal data store 70 in an attempt to match unique data elements to existing consumer objects residing in the consumer object data store 60. In the event that the correlation engine 110 encounters data that is not unique in nature, it utilizes that data to create or refine a general consumer object. Data that can not be used to create or refine a general consumer object is set at a lower processing priority in the event that additional data collection will eventually render that data useful.

In one iteration of FIG. 4, the correlation engine 110 may encounter data that contains an address and social security number which matches an existing consumer object residing in the consumer object data store 60 which is missing the address data element. The correlation engine 110 would then use the data from the temporal data store 70 to insert the address into the consumer object identified by the same social security number that resides in the consumer object data store 60.

In another iteration of FIG. 4, the correlation engine 110 may encounter data that contains only general information concerning a consumer that is interested in personal watercraft. If a general consumer object exists in the consumer object data store 60 that describes consumers that own personal watercraft, then the data residing in the temporal data store 70 would be used to refine that object. Otherwise a new general consumer object would be created and stored in the consumer object data store 60.

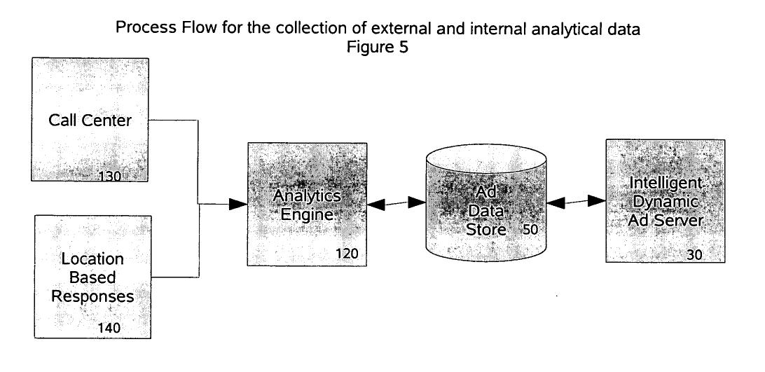

Referring now to FIG. 5, the process flow for the collection of external and internal analytical data into the add data store 50 via the analytics engine 120 and the intelligent dynamic ad server 30 is illustrated. Analytical data concerning the effectiveness of an advertisement is stored in the add data store 50 in relation to a specific advertisement. In the event of an electronic ad serve as discussed previously in FIG. 1, the analytical data is written to the add data store 50 via the intelligent dynamic ad server 30 during the serving process. In cases where an advertisement is delivered using non-electronic means such as a magazine or billboard, the analytics engine 120 interfaces with the most appropriate vehicle to receive consumer feedback concerning that advertisement and inserts it into the add data store 50.

In one implementation of FIG. 5, the advertisement may be delivered via magazine ad space and the analytics engine 120 would track the number of call-ins received via a DID to a telephone number embedded in the print advertisement that consumers could call to receive more information concerning the object of the advertisement.

In another implementation of FIG. 5, the advertisement may be delivered as a posted advertisement in a retail store and the analytics engine 120 would track the total number of RFID tags associated with the advertised product via electronic means in a physical area.

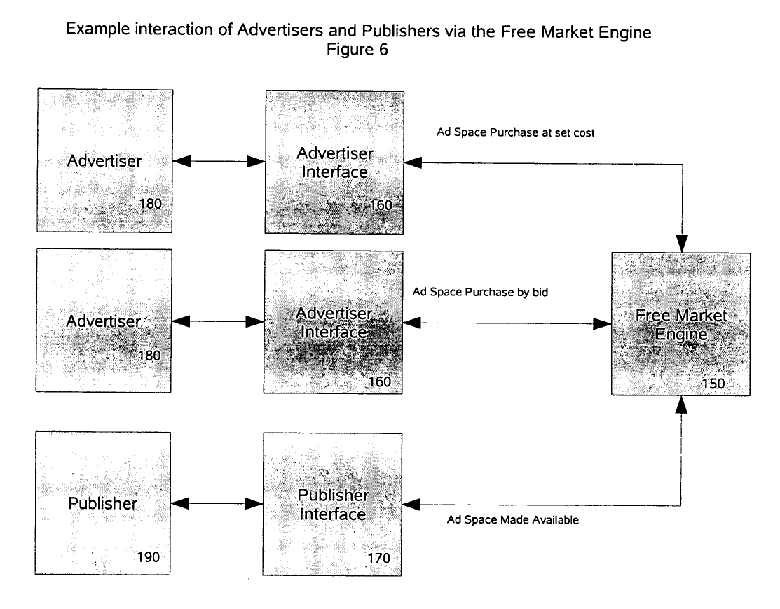

Referring now to FIG. 6, the interaction of advertisers 180 and publishers 190 via the advertiser interface 160, the publisher interface 170, and the free market engine 150 is illustrated. The free market engine 150 provide a framework in which advertisers 180 and publishers 190 can interact to facilitate the buying and selling of advertising space. The free market engine 150 supports both fixed price sales and purchases as well as sales and purchases based upon a bidding process. The advertiser interface 160 provides the functionality specific to the needs of advertisers, and the publisher interface 170 provides the functionality specific to the needs of publishers. Each in turn relies on the free market engine 150 to bridge the divide between buyers and sellers.

Referring now to FIG. 6, the interaction of consumers 210 claiming rewards defined in the add data store 50 is illustrated. Consumers 210 interact with the ad data store 50 where definitions of available rewards are defined on a per advertisement basis. This interaction is accomplished via the consumer rewards interface 200 which presents a simple and user friendly interface to the consumer that allows them to claim rewards to which they are entitled and also informs the consumer of other advertisements that are currently available to them based on personal data that they have entered into the consumer rewards interface 200.

What is claimed is:

1. A media exchange system, comprising:
a central server connected to a network;
a data repository of advertising space for sale or purchase;
at least one publisher connected to a network;
at least one advertiser connected to a network;
the media exchange system allows the advertiser to syndicate advertisements across multiple
media outlets in both electronic and non-electronic formats;

2. The system as in claim 1 wherein the media exchange system provides a platform by which all types of media may be purchased.

3. The system as in claim 1 wherein the media exchange system provides a platform whereby advertisers may purchase advertising space at a set price.

4. The system as in claim 1 wherein the media exchange system provides a platform whereby publishers may sell their advertising space at a set price.

5. The system as in claim 1 wherein the media exchange system provides an auction platform whereby advertisers may bid on advertising space.

6. The system as in claim 1 wherein the media exchange system provides an suction platform whereby publishers may sell their advertising space.

7. The system as claimed in claim 1 wherein the media exchange is a web based portal of modular design.

8. The system as claimed in claim 1 wherein the media exchange includes a plurality of designed modules.

9. The system as claimed in claim 1 wherein the media exchange a publishers interface for the purpose of selling advertising space.

10. The system as claimed in claim 1 wherein the media exchange an advertisers interface for the purpose of purchasing advertising space.

11. An interactive advertising system, comprising:
a central server connected to a network;
a data repository of available advertisements;
a data repository of consumer profiles;
a data repository for the purpose of collecting additional consumer data;
a process by which consumer data is continually validated and updated;
a process by which consumer analytics can be gathered;
at least one requesting interface i.e. consumer connected to the network;

12. The system as claimed in claim 11 provides continual optimization of advertising presentation to the consumer based on consumer algorithms;

13. A consumer rewards system, comprising:
a central server connected to a network;
a data repository of available consumer rewards;
a data repository of consumer profiles;
a data repository for the purpose of collecting additional consumer data;
